(19) United States
(12) Patent Application Publication
(10) Pub. No.: US 2011/0128364 A1
(43) Pub. Date: Jun. 2, 2011

(54) HEAD MOUNTED DISPLAY APPARATUS AND IMAGE SHARING SYSTEM USING THE SAME

(75) Inventor: Takatoshi Ono, Nagoya-shi (JP)

(73) Assignee: BROTHER KOGYO KABUSHIKI KAISHA, Nagoya-shi (JP)

(21) Appl. No.: 12/950,399

(22) Filed: Nov. 19, 2010

(30) Foreign Application Priority Data
Nov. 30, 2009 (JP) 2009-271584

(51) Int. Cl. H04N 7/18; H04N 5/225

(52) U.S. Cl. 348/78; 348/222.1; 348/77; 348/E07.085; 348/E05.024

(57) ABSTRACT

A head mounted display external objects includes: an imaging unit imaging external objects; a first image acquiring unit configured acquiring a first image which shows first information of the work being done by the user; a second image acquiring unit acquiring a plurality of second images which are relevant to specific parts of the first image, the second images showing second information relevant to the first information of the work shown by the first image; a determining unit determining whether or not the plurality of second images are relevant to the work being done by the user, based on the image of external objects; an image forming unit forming, by an image beam, the first image and at least one of the second images determined by the determining unit to be relevant to the work being done by the user.

### CROSS-REFERENCE OF APPLICATION

This application is based upon and claims the benefit of priority of Japanese Patent Application No. 2009-271584 filed on Nov. 30, 2009, the contents of which are incorporated herein by reference in its entirety.

### BACKGROUND

1. Technical Field

The aspect of the disclosure relates to a head mounted display apparatus (hereinafter referred to as a “HMD”) with a imager which images external objects.

2. Description of Related Art

A conventional head mounted display apparatus (HMD) was disclosed in Japanese patent laid-open publication No. H5-303053. The HMD comprises an optical system configured such that images based on image information, can be viewed by a user, together with images of external objects formed by external light. Upon mounting such HMD on the head, a user can view e.g. a manual image and at the same time manipulate items supported by the manual image.

Japanese patent laid-open publication No. 2006-53696 discloses a contents-creating device which displays, on a screen of a personal computer (PC) or the like, an attached image based on attached information that is relevant to a specific item in the manual image. With adaptation of this contents-creating device to the HMD, a user can operate the items supported by the manual image while viewing the attached image based on the attached information. That is, the HMD allows a user to view the attached image, which indicates whether or not the work of a specific item in the manual image is performed as the specific item instructs, or the like. Thus, a user can efficiently perform the work that the manual image instructs.

If such HMD is accessible to a network system, including a server, database, and the like, and also has a camera configured to image external objects within the field of user's view, it is possible for a user to share, with other users, e.g. the exemplary cases where the user fails in performing the work that the manual image instructs during viewing the manual. For example, in the case that a user intended to place an object on a region within the field of user's view, but actually he/she placed it on a wrong region, the field of user's view at that time is imaged by the camera in correspondence with time. The image is provided to other user over a network. The image provided to other user is viewed by the former user in correspondence with a specific item of the manual image that other user views. Other user can also view an image relevant to an example of failure conducted by a specific user, so that he/she can do work with careful caution not to repeat the same failure.

### SUMMARY

However, all images, provided over a network system, are not necessarily important to users. For example, in the case that a specific user is doing work which is completely different from that done by other user, if the images, irrelevant to the work done by the specific user, are provided from other user, and the specific user is viewing all of those images, such images may hinder the specific user from doing his work.

One of the aspects of the disclosure is to provide a head mounted display apparatus which allows a user to view only images that are based on the information that is relevant to the work being done by the user, and an image sharing system using the same.

According to one of the aspects, there is provided a head mounted display apparatus to be worn on a head of a user or the vicinity of the head of the user to allow an image to be visually recognized by the user together with image of external objects formed by external light, the head mounted display apparatus comprising:

an imager configured to image external objects which shows a work being done by the user;

a first image acquiring unit configured to acquire a first image which shows first information of the work being done by the user, which is relevant to the external objects;

a second image acquiring unit configured to acquire a plurality of second images which are relevant to specific parts of the first image, the second images showing second information relevant to the first information of the work shown by the first image;

a determining unit configured to determine whether or not the plurality of second images are relevant to the work being done by the user, based on the external objects;

an image forming unit configured to form, by an image beam, the first image and at least one of the second images determined by the determining unit to be relevant to the work being done by the user.

### BRIEF DESCRIPTION OF THE DRAWINGS

FIG. 1 is a view showing the state where a user (PR) is doing his work using a head mounted display (HMD) 1.

FIG. 2 is an enlarged plan view showing the HMD 1.

FIG. 3 is a diagram explaining electrical, optical configurations of the HMD 1.

FIG. 4 is a diagram explaining an image sharing system 100 having the HMD 1 and other HMDs (1A, 1B, and 1C) with the same construction as the HMD 1.

FIG. 5A is a flow chart showing a main process of the HMD 1.

FIG. 5B is a flow chart showing in detail the step SA3 of the process shown in FIG. 5A.

FIG. 5C is a flow chart showing in detail the step SA4 of the process shown in FIG. 5A.

FIG. 5D is a flow chart showing in detail the step SA5 of the process shown in FIG. 5A.

FIG. 5E is a flow chart showing a process of adding a new attached image (AC) of the HMD 1 to determination table (TB2).

FIG. 6 is a view showing a combined image of external objects (BG) and a manual image (MN) which is visible to a user (PR) equipped with the HMD 1.

FIG. 7 is a diagram for explaining the manual image (MN) shown by the HMD 1.

FIG. 8 is a view showing exemplary determination table (TB1) which is stored in a DB server 200 and acquired by the HMD 1.

FIG. 9 is a view showing exemplary determination table (TB2) which is stored in a DB server 200 and acquired by the HMD 1.

FIG. 10A is a diagram explaining the attached image (AC) shown by the HMD 1.

FIG. 10B is a diagram explaining the attached image (AC) shown by the HMD 1.

FIG. 11 is a view showing an exemplary superposed combined image of external objects (BG) and a manual image (MN) which is visible by a user (PR) equipped with the HMD 1.

FIG. 12 is a view showing determination table (TB3) written by adding attached image (AC) of ID number M2A4 to the determination table (TB2) shown in FIG. 9.

FIG. 13 is a diagram for explaining an image sharing system 900 having the HMD 1 and other HMDs (1A, 1B, and 1C) with the same construction as the HMD 1, according to a first modification.

FIG. 14 is a flow chart showing a procedure of a process replacing the SA2 shown FIG. 5A according to a second modification.

FIG. 15 is a diagram explaining the procedure shown in FIG. 14.

FIG. 16 is a flow chart showing a procedure of a process replacing the SA2 shown FIG. 5A according to a third modification.

FIG. 17 is a diagram explaining the procedure shown in FIG. 16.

### DETAILED DESCRIPTION

Aspects of the disclosure will now be described with reference to the accompanying drawings. The retinal scanning display is a head mounted display (HMD) which is mounted in the vicinity of the head of a user so as to two dimensionally scan an image beam onto the user's retina. The retinal scanning display allows a user to view an image (hereinafter referred to as a “contents image”) corresponding to the contents information with the 2D scanning of an image beam onto the user's retina.

There are two types of the term “viewing”. The first type is that an image beam is 2D-scanned onto the user's retina so that a user perceives the image, and the second type is that an image is displayed on a display panel or the like, and a user perceives the image formed by an image beam which is projected from the image displayed on the display panel or the like. The term of “display” hereinafter means an operation being conducted so that a user is able to perceive an image formed by an image beam. In this context, either of the types may be considered to display an image formed by an image beam.

[Appearance of HMD]

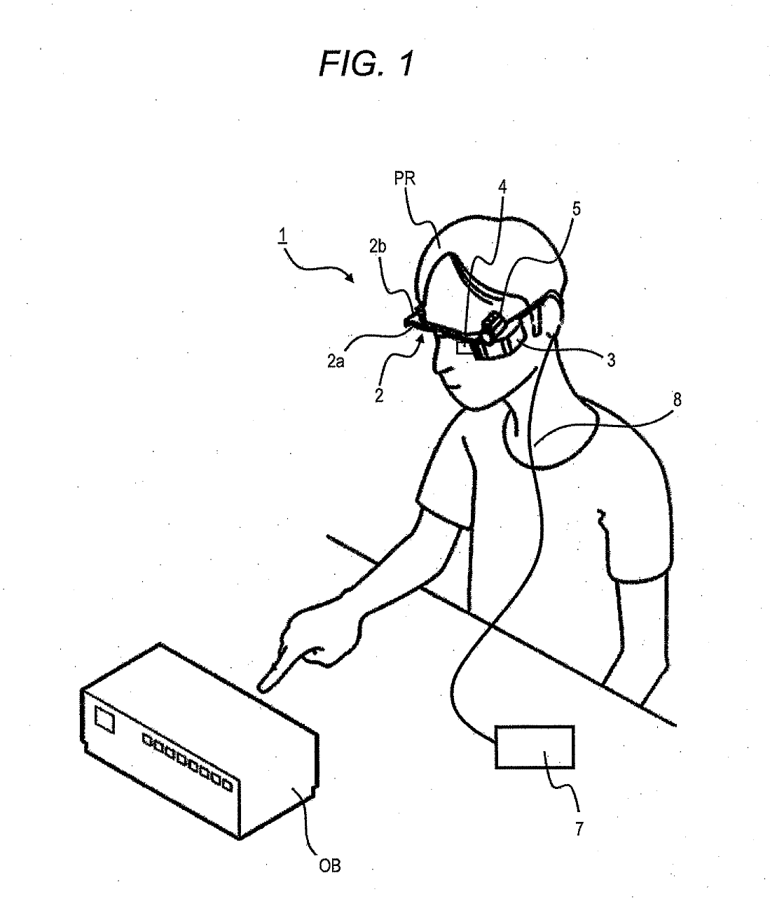

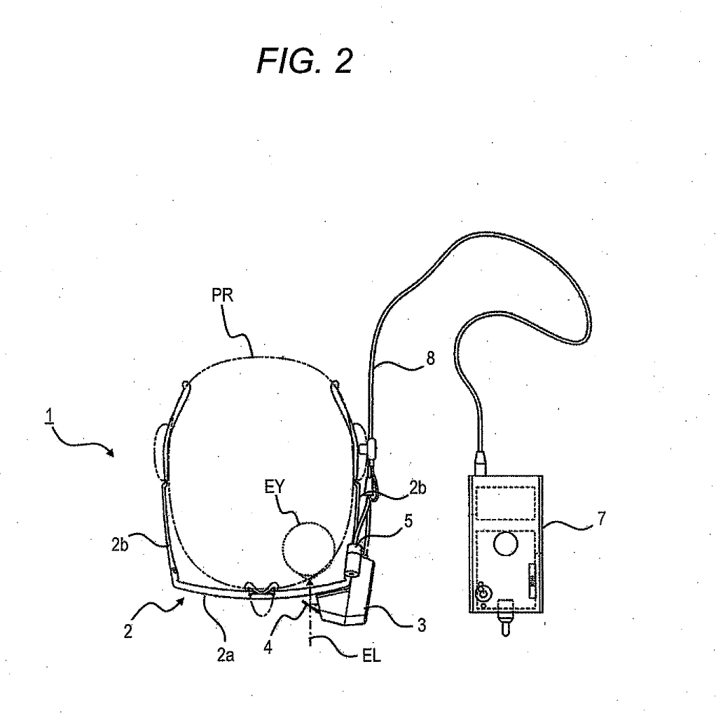

As shown in FIGS. 1 and 2, the HMD 1 comprises a frame unit 2, an image display unit 3, a half mirror 4, a CCD 5, a system box 7, and a transmission cable 8.

The HMD 1 is a retinal scanning display which displays a variety of contents information, such as a manual, a document file, an image file, a moving picture film, or the like, as images in such a manner as to enable a user (PR) who mounts the frame unit 2 onto the head to view the image.

The frame unit 2, as shown in FIGS. 1 and 2, is of a shape of glasses frame and comprises front part 2a and a pair of temples 2b.

The image display unit 3, as show in FIGS. 1 and 2, is attached to the left side temple 2b as viewed by a user (PR). The image display unit 3 2D-scans an image beam to form the image beam for displaying the contents image.

The half mirror 4, as shown in FIGS. 1 and 2, is provided on the front part 2a. The half mirror 4 reflects an image beam generated from the image display unit 3 and directs the image beam towards the retina of a user's eyes (EY). Since the half mirror 4 is translucent and through which external light (EL) passes, a user (PR) wearing the HMD 1 can view the contents image together with the image of external objects formed by external light. Thus, a user (PR) can do his work, such as assembly and attachment, as shown in FIG. 1, while viewing the contents image such as a manual or the like.

The image display unit 3 reflects an image beam at a predetermined location of the half mirror 4 and directs it to the user's retina, based on data stored in a ROM which will be described later. According to the reflection range and mounting location of the half mirror 4, the range, position, and direction that a user views the contents image are predetermined.

The CCD (Charge Coupled Devices) 5 is attached onto the image display unit 3. An optical axis of the CCD 5 is provided such that the optical axis is substantially identical to an incident direction of the image beam to the retina when an image beam is reflected from the half mirror and directed to the user's retina. With such a configuration of the optical axis, it is possible for the CCD 5 to image external objects in the range that is substantially identical to the range that a user (PR) views the contents image.

The system box 7 is connected to the image display unit 3 via the transmission cable 8. The system box 7 generally controls the whole operation of the HMD 1. Further, the system box 7 is able to communicate with an external device such as a DB (Data Base) server which however is not shown in FIGS. 1 and 2. The system box 7 acquires contents information for showing a contents image, such as a manual image, through such communication with an external device to the user PR. The transmission cable 8 may comprise either fiber-optic cables or other cables for transmitting a variety of signals.

[Electrical Configuration of HMD]

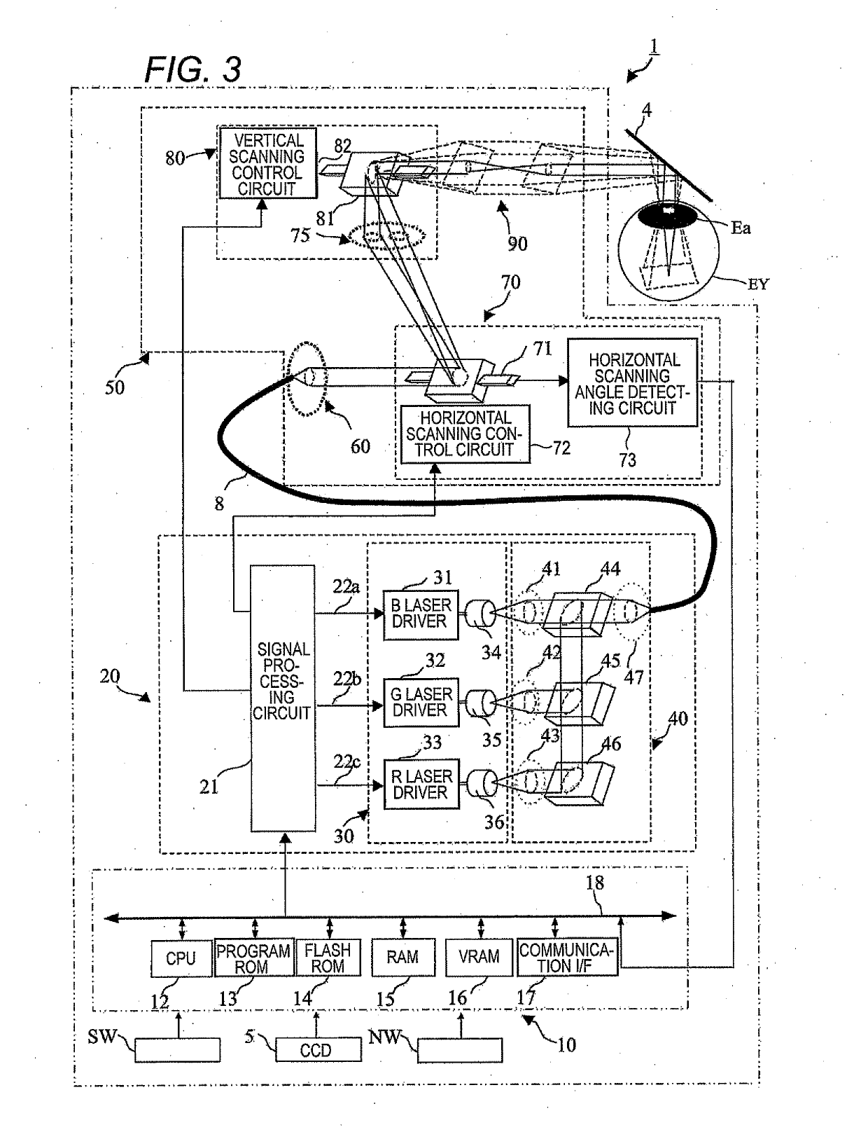

The electrical configuration of the HMD 1 will now be described with reference to FIG. 3.

The HMD 1 comprises a general controller 10, a beam-generating unit 20, and a beam-scanning unit 50, as shown in FIG. 3. The general controller 10 and the beam-generating unit 20 are housed in the system box 7, and the beam-scanning unit 50 is housed in the image display unit 3.

The general controller 10, as shown in FIG. 3, a central processing unit (CPU) 12, a program read only memory (ROM) 13, a flash ROM 14, a random access memory (RAM) 15, a video random access memory (VRAM) 16, a communication interface (I/F) 17, and a bus 18. The CPU 12 is an operation processing unit which executes a variety of information processing programs stored on the program ROM 13 so as to execute a variety of functions of the HMD 1. The program ROM 13 comprises a flash memory, a non-volatile memory. The program ROM 13 stores thereon a variety of information processing programs executable by the CPU 12. For example, the information processing program may be an information processing program for operating the beam-generating unit 20 and the beam-scanning unit 50 when performing a control of e.g. play, stop, fast forward, rewind of the contents displayed by the HMD 1. The flash ROM 14 is able to store image data or a plurality of kinds of tables to which the general controller 10 refers when controlling the display of various kinds of items. The RAM 15 temporarily stores many kinds of data such as image data or the like. The VRAM 16 has an area on which upon displaying of an image, the image to be displayed is temporarily drawn before being displayed. The communication I/F 17 is a network interface for gaining access via wireless LAN to a system for sharing an image formed on one HMD 1 with another HMD mounted on other user. The CPU 12, the program ROM 13, the flash ROM 14, the RAM 15, the VRAM 16, and the communication I/F 17 are respectively connected to a data communication bus 18, via which various kinds of information is transmitted and received. The general controller 10 is connected with a power switch (SW), a renewal switch (NW), and the CCD 5 of the HMD 1 as shown in FIG. 3. The CPU 12, the program ROM 13, the RAM 15, or the like configure a microcomputer of the HMD 1. The renewal switch (NW) is turned ON, a new pickup image is supplied to the DB server 200.

As shown in FIG. 3, the beam-generating unit 20 comprises a signal processing circuit part 21, a beam source part 30, and a beam combining part 40. The beam-generating unit receives image data supplied from the general controller 10. The signal processing circuit 21 generates image signals 22a to 22c of Blue, Green, and Red, which are image-combining elements, based on the supplied image data, and supplies them to the beam source part 30. The signal processing circuit 21 supplies a horizontal drive signal to a horizontal scanning part 70 to drive the same, and also supplies a vertical drive signal to a vertical scanning part 80 to drive the same.

The beam source part 30 serves as an image beam projector for projecting an image beam according to three imager signals 22a to 22c supplied from the signal processing circuit 21. The beam source part 30 comprises a B laser 34 projecting an image beam of blue color and a B laser driver 31 driving the B laser 34, a G laser 35 projecting an image beam of green color and a G laser driver 32 driving the G laser 35, and a R laser 36 projecting an image beam of red color and a R laser driver 33 driving the R laser 36.

The beam combining part 40 receives three image beams projected from the beam source part 30, and combines the three image beams into an arbitrary single image beam. The beam combining part 40 collimates an image beam incident from the beam source part 30. The beam combining part 40 comprises collimating lenses 41, 32, and 43, dichroic mirrors 44, 45, and 46 for combining the collimated image beams, and a coupling lens 47 for guiding the combined image beam to the transmission cable 8. Laser beams projected from the respective lasers 34, 35, and 36 are collimated by the collimating lenses 41, 42, and 43, and then are incident to the dichroic mirrors 44, 45, and 46. Then, the respective image beams are selectively reflected from or transmitted through the dichroic mirrors according to their wavelengths.

The beam-scanning unit 50 comprises a collimating optical system 60, a horizontal scanning part 70, a vertical scanning part 80, and relay optical systems 75 and 90. The collimating optical system 60 collimates the image beam projected via the transmission cable 8 and directs the collimated beam to the horizontal scanning part 70. The horizontal scanning part 70 comprises a resonant deflecting element 71, a horizontal scanning control circuit 72, and a horizontal scanning angle detecting circuit 73. The resonant deflecting element 71 has a reflective surface for scanning the image beam horizontally. The horizontal scanning control circuit 72 resonates the resonant deflecting element 71 based on a horizontal drive signal 23 supplied from the signal processing circuit 21. The horizontal scanning angle detecting circuit 73 detects the oscillating state such as an oscillating range, an oscillating frequency, etc. of the reflective surface of the resonant deflecting element 71 based on a deflecting signal supplied from the resonant deflecting element 71. The horizontal scanning angle detecting circuit 73 supplies a signal indicative of the detected oscillating state of the resonant deflecting element 71 to the general controller 10. The relay optical system 75 relays the image beam between the horizontal scanning part 70 and the vertical scanning part 80. The beams, horizontally scanned by the resonant deflecting element 71, are focused upon the reflective surface of a deflecting element 81 of the vertical scanning part 80 by the relay optical system 75. The vertical scanning part 80 comprises the deflecting element 81 and a vertical scanning control circuit 82. The deflecting element 81 scans the image beams, directed by the relay optical system 75, in a vertical direction. The vertical scanning control circuit 82 oscillates the deflecting element 81 based on a vertical drive signal 24 supplied from the signal processing circuit 21. The image beams, which are horizontally scanned by the resonant deflecting element 71 and then are vertically scanned by the deflecting element 81, are the two-dimensionally scanned image beams and are directed to the relay optical system 90. The relay optical system 90 converts the respective image beams, scanned by the resonant deflecting element 71 and the deflecting element 81, such that the respective center lines become substantially parallel with each other, and collimates the respective image beams. The relay optical system 90 converts the respective image beams such that the respective center lines are focused upon an pupil (Ea) of a user (PR).

The image beams supplied from the relay optical system 90 are reflected once by the half mirror 4 and are focused upon the pupil (Ea) of a user (PR). Thus, the user (PR) can view the content image.

The general controller 10 receives a signal based on the oscillating state of the resonant deflecting element 71 from the horizontal scanning angle detecting circuit 73. The general controller 10 controls the operation of the signal processing circuit 21 based on the received signal. The signal processing circuit 21 supplies a horizontal drive signal to the horizontal scanning control circuit 72, and also supplies a vertical drive signal to the vertical scanning control circuit 82. The horizontal scanning control circuit 72 controls a motion of the resonant deflecting element 71 based on the supplied horizontal drive signal. The vertical scanning control circuit 82 controls a motion of the deflecting element 81 based on the supplied vertical drive signal. By the above serial processes, the horizontal scanning and the vertical scanning become synchronized.

[Constitution of Image Sharing System]

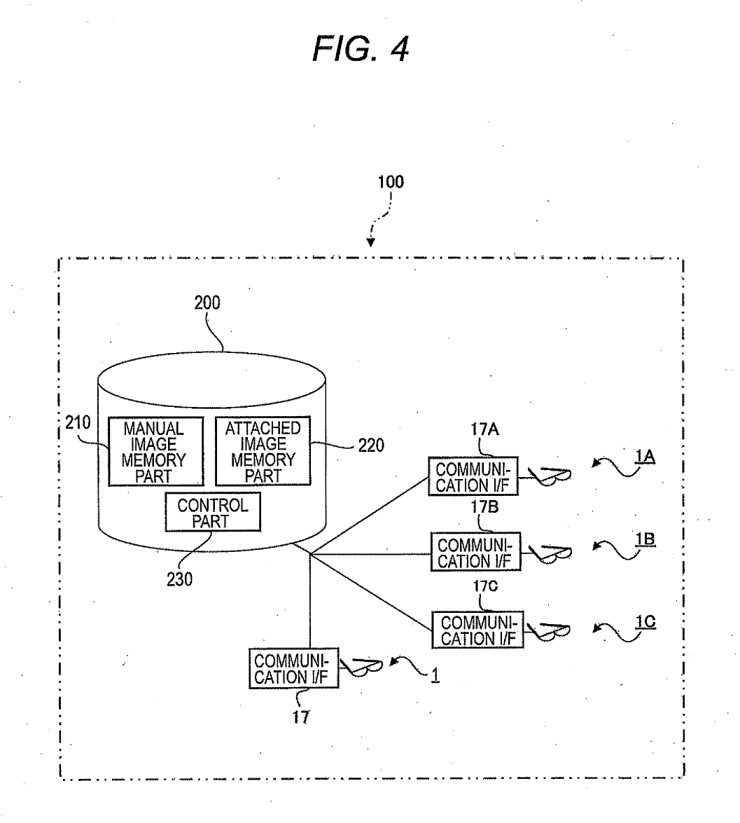

In FIG. 4, HMDs 1A, 1B, and 1C have the same constitution as the HMD 1 of FIG. 3. In FIG. 4, a HMD, 1 mounted by a user (PR), and the HMDs 1A, 1B, and 1C, mounted by other three users, are illustrated. The three users wearing the HMDs 1A, 1B, and 1C, respectively also do their work of assembly and attachment as the user (PR) of FIG. 1 does. As shown in FIG. 4, the HMD 1 and the HMDs 1A, 1B, and 1C are connected to a database server (hereinafter referred to as a “DB server”) 200 through wireless communication via communication I/Fs 17, 17A, 17B, and 17C, respectively. The DB server 200 comprises a CPU, a ROM, a RAM, and the like. The DB server 200 comprises a manual image memory part 210 storing a manual image in advance. The DB server 200 comprises an attached image memory part 220 storing an attached image in advance. The DB server 200 comprises a control unit 230 storing on a second image memory part image of external objects, supplied from the HMDs 1A, 1B, and 1C, as a new attached image. The DB server 200 is capable of simultaneously supplying certain stored data to two or more HMDs among the HMDs 1A, 1B, and 1C. Further, the DB server 200 is capable of supplying certain stored data to any one of the HMDs 1A, 1B, and 1C.

[Controlling Process of HMD]

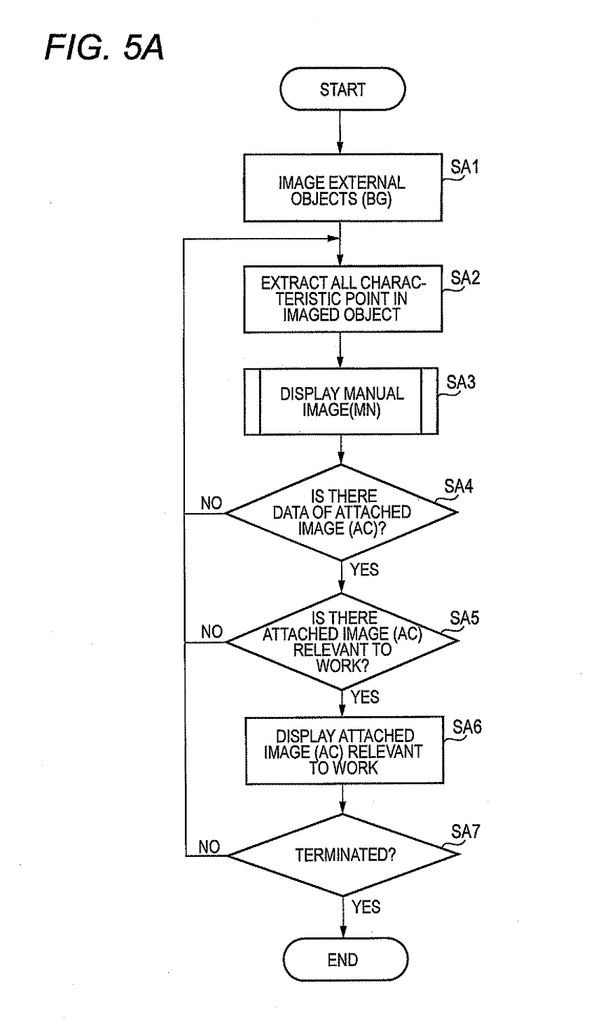

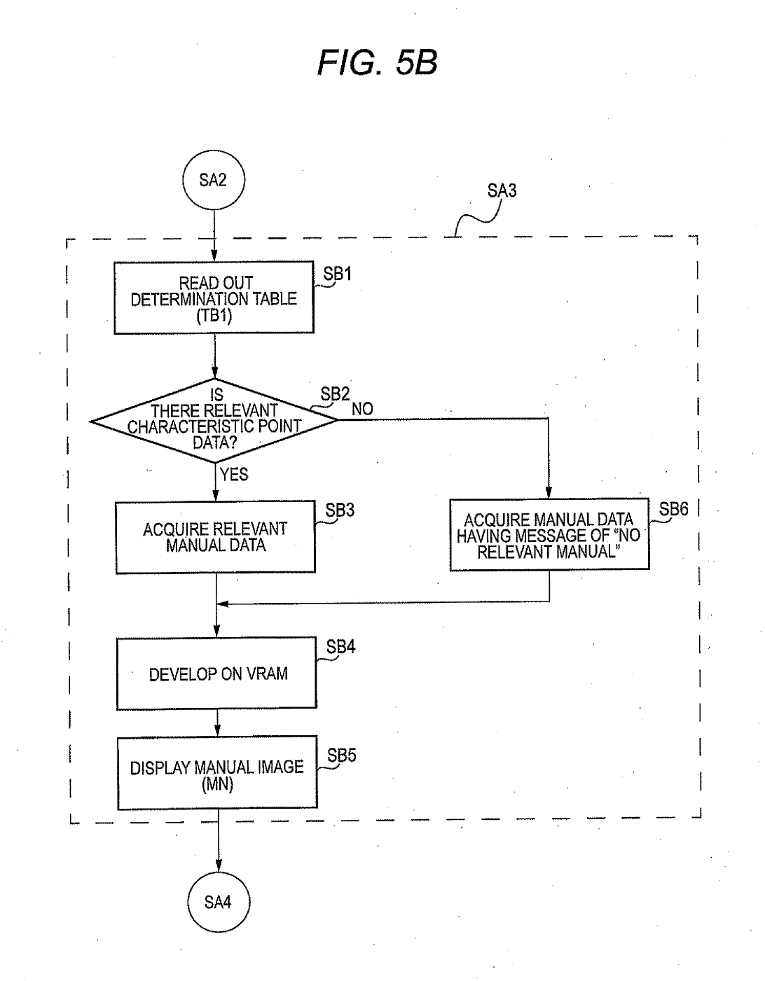

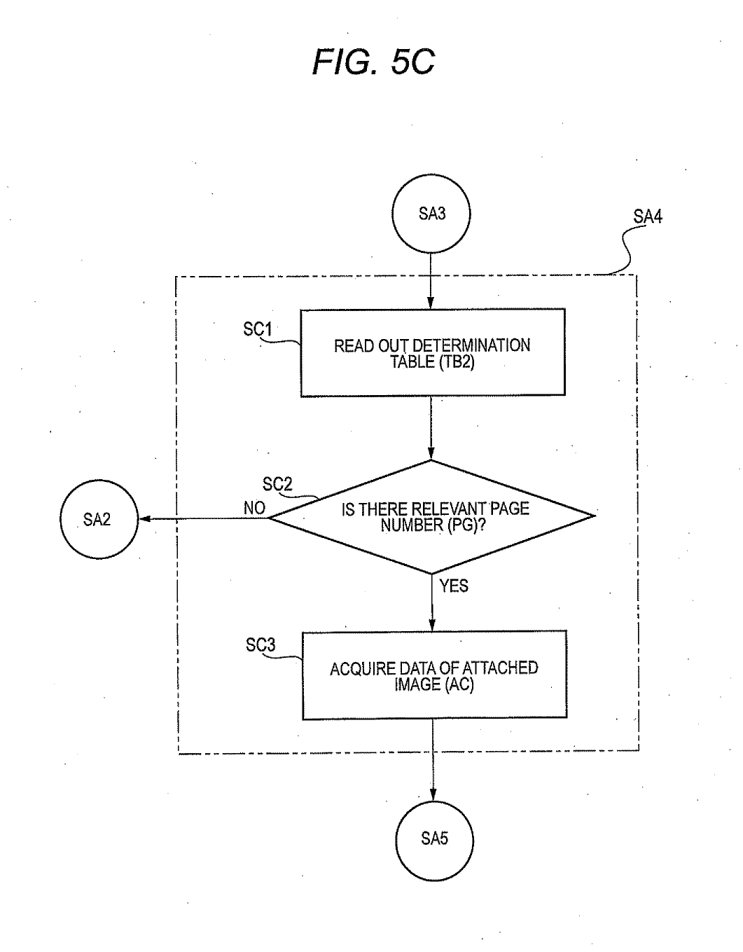

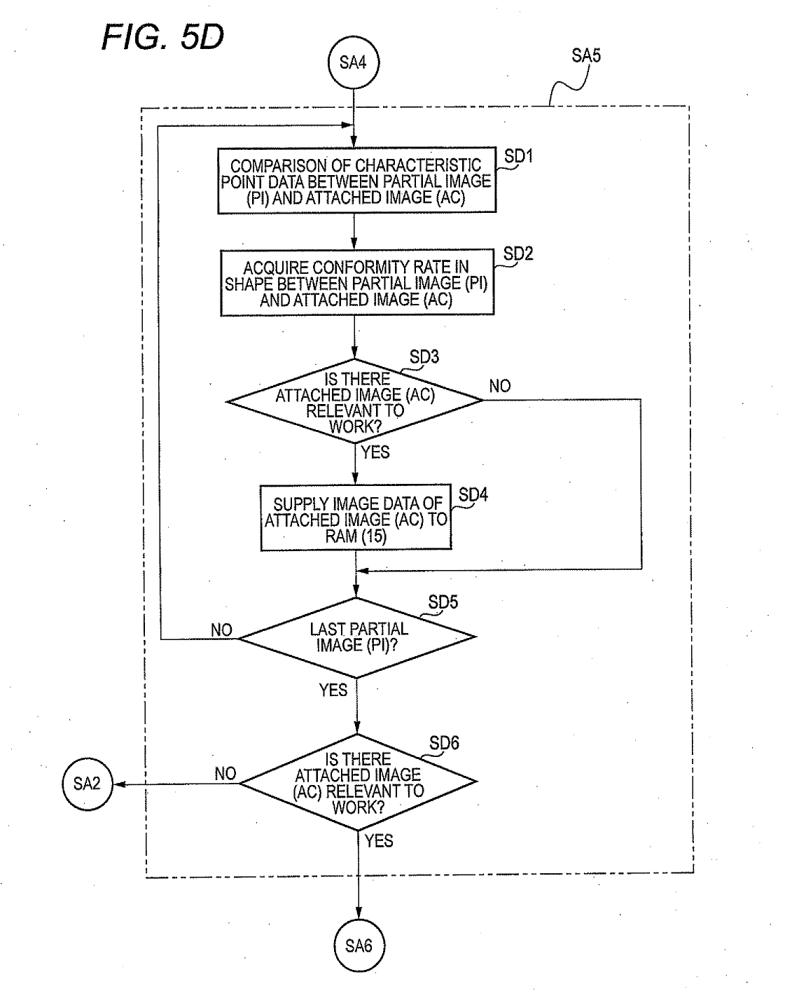

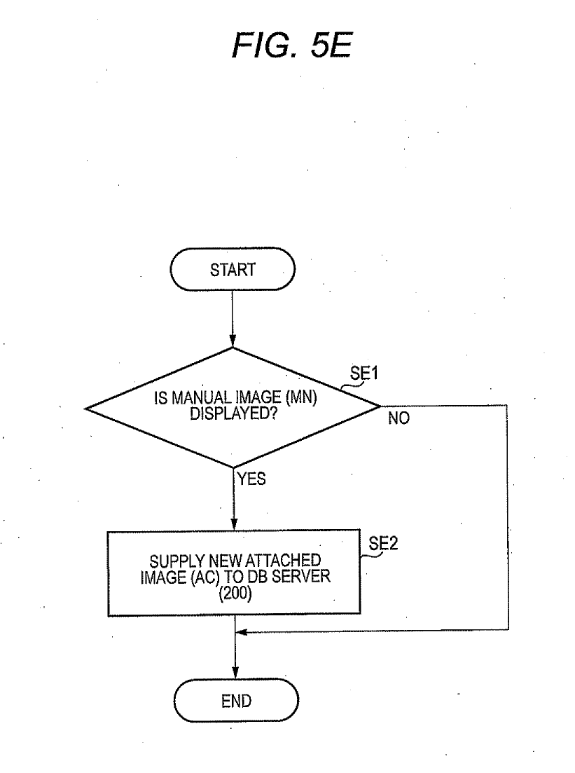

Next, the controlling process of the HMD 1 will be described with reference to FIGS. 5A to 5D. The HMDs 1A, 1B, and 1C shown in FIG. 4 perform the same controlling process as that of the HMD 1 described below. The controlling process is executed by the CPU 12.

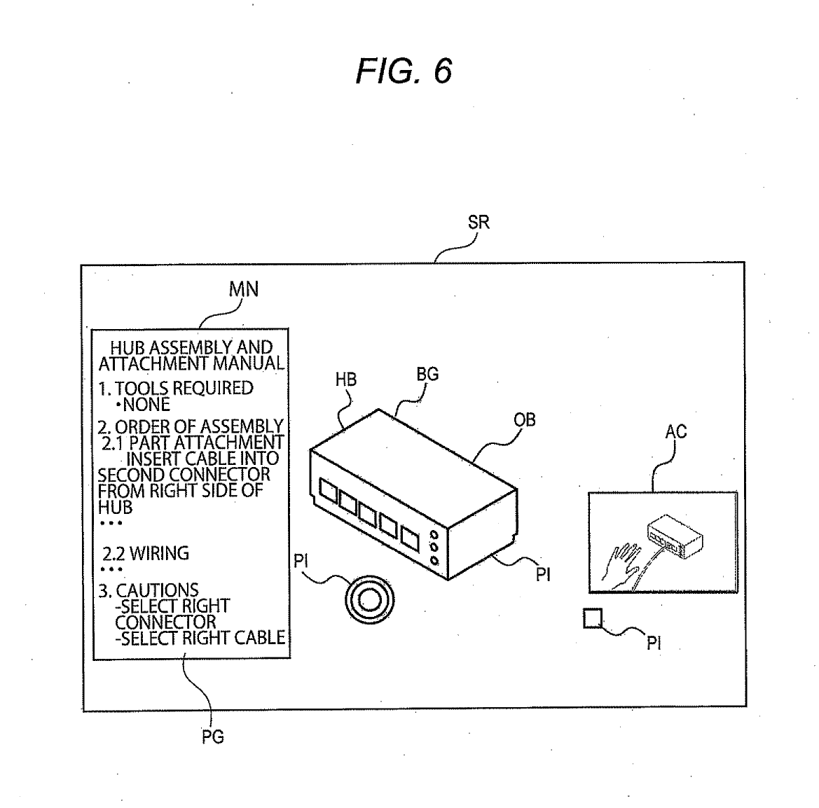

In the control process of the HMD 1, the CCD 5 first images external objects (BG) (Act SA1; hereinafter referred to as ‘SA1’). Here, the CCD 5, as shown in FIG. 6, images the external objects within the image range (SR). Data of external objects (BG) imaged by the CCD 5 is stored on the RAM 15.

After the external objects (BG) is imaged, all characteristic points are extracted from the image of the external objects imaged by the CCD 5 (SA2). With extraction of all the characteristic points within the pickup image, coordinate data of all partial images P1 within the external objects (BG) are acquired. Thus, since data on positions of the characteristic points of all the partial images P1 and positional relationship between the respective characteristic points are acquired, the shapes of the plurality of partial images P1 within the external objects shown in FIG. 6 can be recognized. The extraction of the characteristic points and the shape recognition of the partial images P1 are acquired by means of known edge detection technology by Sobel operator or the like.

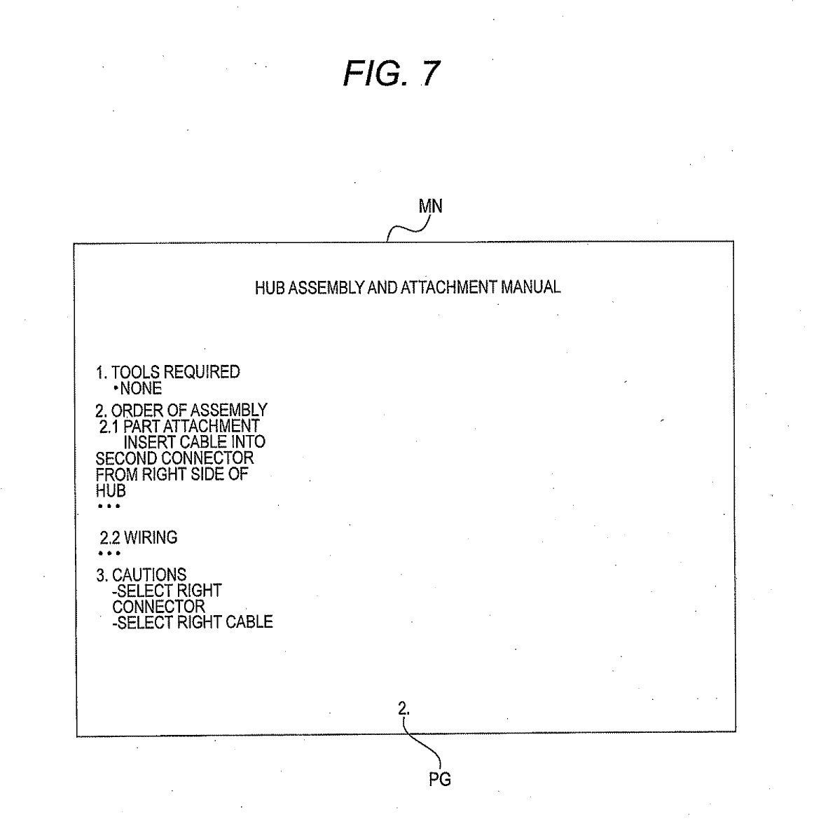

When extracting the characteristic points, a manual image (MN) is displayed as shown in FIGS. 6 and 7 (SA3). In FIGS. 6 and 7, the manual image (MN) is a manual image (MN) whose page number (PG) is 2. SA3 will be described in detail with reference to FIG. 5B.

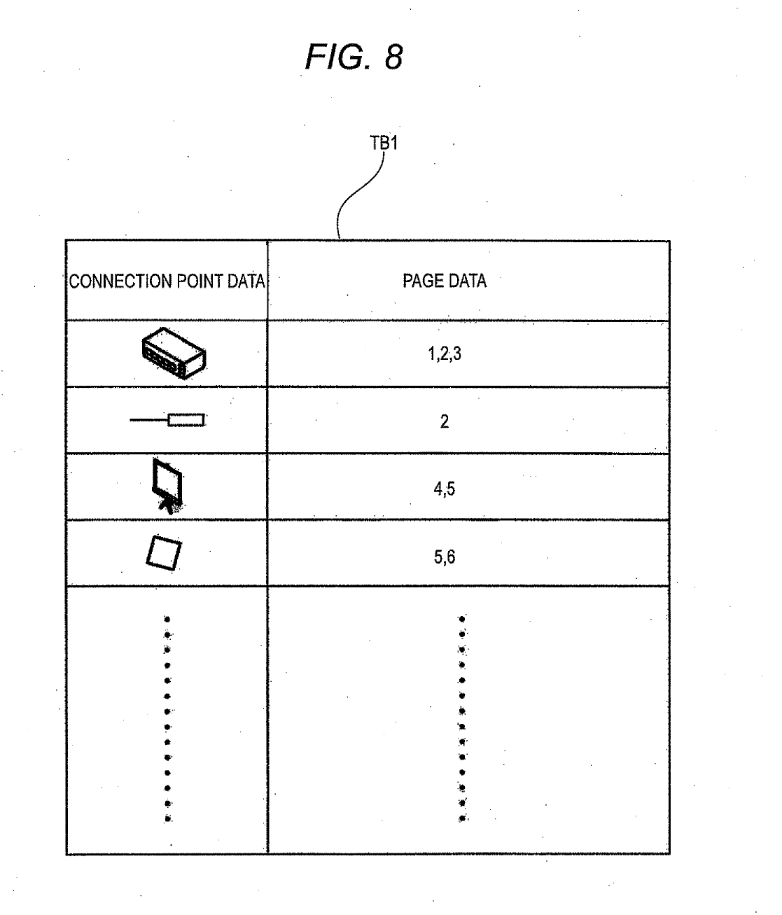

When the characteristic points are extracted in SA2, the determination table (TB1), which was stored in the DB server 200, is read out (SB1). The determination table (TB1), as shown in FIG. 8, is table stored in the DB server 200, and the characteristic point data relevant to the page data. In the disclosure, the characteristic point data is a collection of coordinate data of the characteristic points which form an image. In FIG. 8, for simplification, an image is illustrated which is formed by the plurality of characteristic points as the respective characteristic point data. As shown in FIG. 8, the characteristic point data forming a hub-like image (FIB) is stored in the first item of the determination table (TB1). As shown in FIG. 8, the characteristic point data forming cable, screen, screen sheet images, respectively, are stored in the second, third, and fourth items of the determination table (TB1). Further, in FIG. 8, the page data “1, 2, 3” means that the page number (PG) of the manual image (MN) is 1, 2, and 3.

When the determination table (TB1) is read out, it is determined whether or not there is data corresponding to the characteristic point data extracted in SA2 in the items of the characteristic point data of the determination table (TB1) (SB2).

If the determination result is YES (SB2: YES), the manual data of the page data corresponding to the relevant characteristic point data in the determination table (TB1) is acquired from the manual image memory part 210 of the DB server 200 shown in FIG. 3. The manual data acquired from the DB server 200 is image data for displaying a manual image (MN) of the page number (PG) shown in the page data. The acquired manual data is supplied to the RAM 15 (SB3).

When the manual data is supplied to the RAM 15, the manual data is supplied to the VRAM 16 and is stored in the VRAM 16 (SB4). When the manual data is stored in the VRAM 16, a manual image (MN) based on the manual data is displayed (SB5). Further, if the page data is “1, 2, 3”, for example, the first, second, and third pages of the manual image (MN) are displayed in order.

If as the determination result of SB2, there is no data corresponding to the characteristic point data extracted in SA2 in the items of the characteristic point data of the determination table (TB1) (SB2: No), the manual data of the manual image (MN) having a message of “there is no relevant manual” is supplied to the RAM 15 from the DB server 200 (SB6). When the manual data is supplied to the RAM 15 in SB6, the process proceeds to SB4, and the manual image (MN) having a message of “there is no relevant manual” then is displayed (SB5). With the display of manual image (MN), a user (PR) can view a combined image that the manual image (MN) is superposed on the image of the external objects (BG), as shown in FIG. 6.

The process of SA3 will be described with reference to FIGS. 6 and 8. As shown in FIG. 6, a hub-like image (HB) is within the present image range (SR). With the hub-like image (HB) being within the image range (SR), according to the determination table (TB1) shown in FIG. 8, the manual data of page data “1, 2, 3” are acquired in SB3 shown in FIG. 5B. With obtaining of the manual data “1, 2, 3”, the first, second, and third pages of the manual image (MN) are displayed in order in SB5 shown in FIG. 5B. As shown in FIG. 6, the first page of the manual image (MN) has already been displayed and the second page of the manual image (MN) is also currently displayed. The manual image (MN), as shown in FIG. 6, is an image showing parts and tools required for work, or contents and order of work. Thus, a user (PR) can do his work with respect to its contents which are instructed by the manual image (MN), while viewing the manual image (MN).

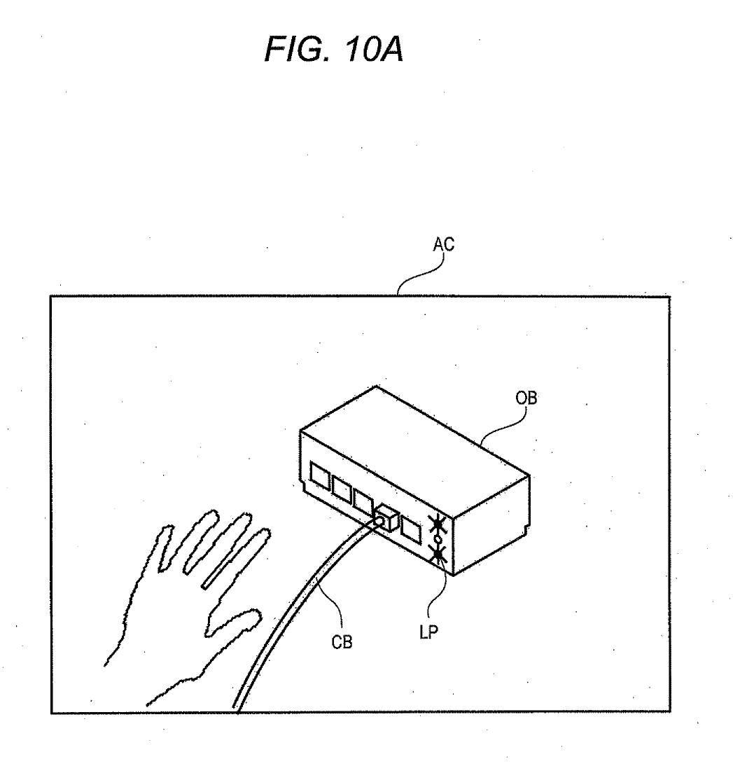

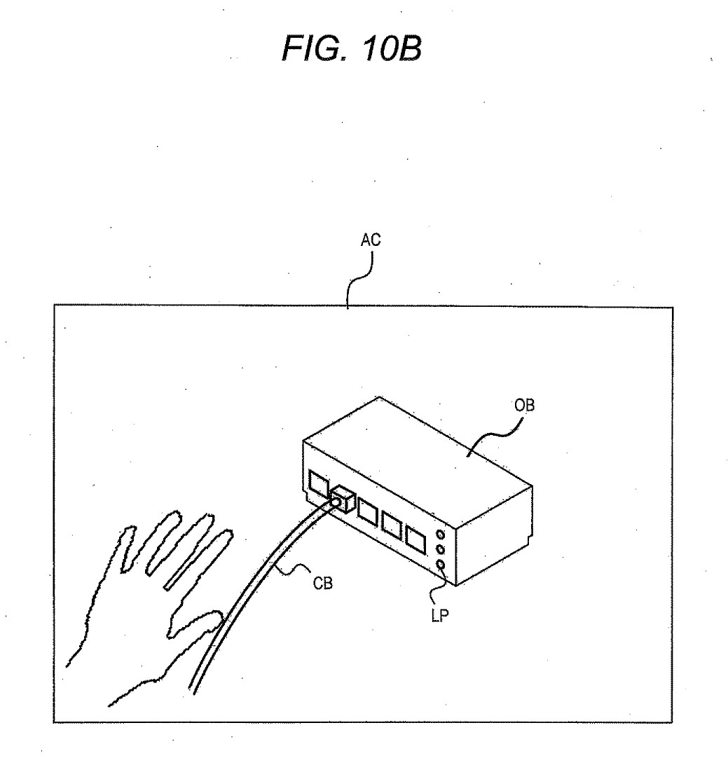

When the manual image (MN) is displayed, it is determined whether or not there is data of a plurality of attached images (AC) relevant to the page number (PG) of the displayed manual image (MN) (SA4). The attached image (AC) is an image for showing a user information attendant to the contents and order of work. The attached image (AC) acquired by the DB server 200 is at least two images which are shown in FIGS. 10A and 10B and are relevant to the page number (PG) of the manual image (MN). In the disclosure, the attached image (AC), stored in the DB server 200 in advance, is an image of successful case as shown in FIG. 10A. The attached image (AC) of FIG. 10A shows the successful case in which, in the work that a cable (CB) is fitted into a certain position of a target object, which is displayed as an object image (0B), the cable (CB) is properly fitted into the desired position and therefore a normal-state lamp (LP) is turned on. In the disclosure, the attached image (AC), stored by the DB server 200, may also comprise an image of case of failure as shown in FIG. 108, in addition to the successful case shown in FIG. 10A. The image of FIG. 10B is an image which is stored in the DB server 200 as a new attached image (AC) when a user (PR) and three other users, who mount the HMDs 1A, 1B, and 1C, respectively, turn on the renewal switch (NW). The attached image (AC) of FIG. 10B shows an image of case of failure in which, in the work that a cable (CB) is fitted into a certain position of a target object, which is displayed as an object image (OB), the cable (CB) is fitted into an inappropriate position and therefore a normal-state lamp (LP) is not turned on. Making the attached image (AC), shown in FIGS. 10A and 10B, visible to a user (PR), information attendant to the contents and order of work being done by the user (PR) can be shown to the user (PR).

SA4 will now be described in detail with reference to FIG. 5C.

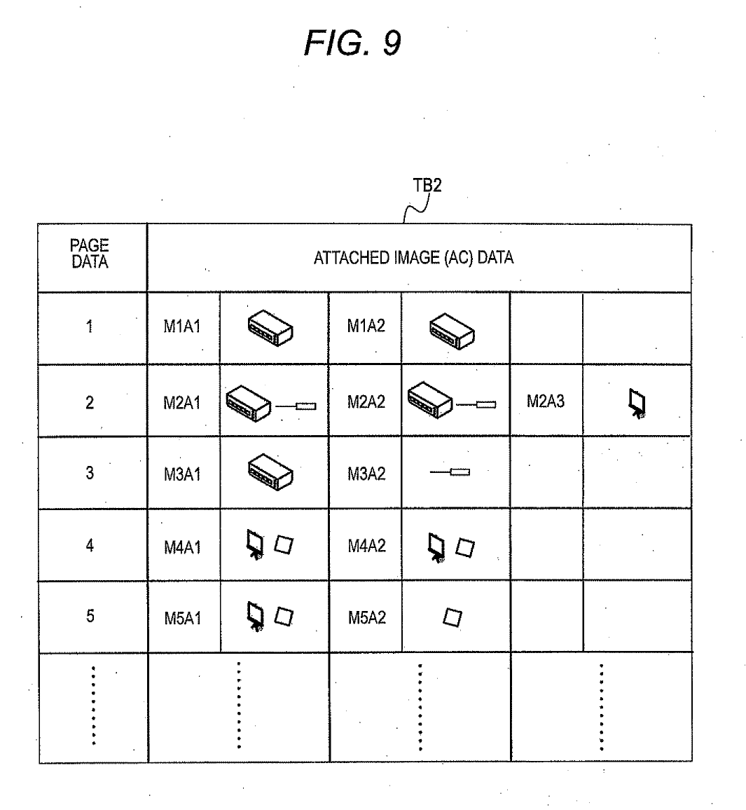

In this process, the determination table (TB2) stored in the DB server 200 is first read out via the communication I/F 17 (SC1). The determination table (TB2) is table in which the page data and the attached image (AC) data are arranged to correspond to each other as shown in FIG. 9, and are stored on the attached image memory part 220 of the DB server 200 shown in FIG. 4. The data of attached image AC, as shown in FIG. 9, comprises an ID number of the attached image such as M1A1, M2A1, etc., and the same characteristic point data of the attached image (AC) as the characteristic point data shown in FIG. 8. If the ID number shown in FIG. 9 is MXAY, X indicates the page number, and Y indicates the number allocated to the respective attached images (AC) arranged to correspond to the respective page numbers. The characteristic point data shown in FIG. 9, in case of the attached image (AC) of the ID number M2A1, for example, indicates a collection of coordinate data of the plurality of characteristic points which constitute the hub-like image (HB) and the cable image (CB).

When the determination table (TB2) is read out, it is determined whether or not there is something to correspond to the page number (PG) in the currently-displayed manual image (MN) in the item of the page data of the determination table (TB2) (SC2).

If the determination result is YES (SC2: YES), the plurality of attached image (AC) data, relevant to the page data, are acquired (SC3). If the determination result of SC2 is NO (SC2: No), the process proceeds to S2 because there is no attached image (AC) data relevant to the page number (PG) in the manual image (MN). Also in the case that the manual image (MN) having a message of “there is no relevant manual” is displayed in SB6 of FIG. 5B, it is determined in SC2 that there is nothing to correspond to the page number (PG) in the currently-displayed image, and the process proceeds to SA2.

The process of SA4 will now be described with reference to FIGS. 6 and 9. As shown in FIG. 6, the manual image (MN) whose current page number (PG) is 2 is displayed. Thus, since the page data shown in FIG. 9 is “2”, SC2 determines that there is data to correspond to the page number (PG) in the currently displayed image. When this determination process has been carried out, data of the plurality of attached images (AC) to correspond to the relevant characteristic point data are acquired. That is, data of three attached images (AC) of the ID numbers M2A1, M2A2, and M2A3, relevant to the page data “2” in the determination table (TB2) shown in FIG. 9, are acquired.

If SA4 shown in FIG. 5A determines that there is data to correspond to the characteristic point data of the attached image (AC) which is relevant to the page number (PG) in the manual image (MN), and the data of the plurality of attached images (AC) is acquired in SC3, it is determined whether or not there is at least one attached image (AC) which is relevant to work, among the plurality of attached images (AC) (SA5). SA5 will now be described in detail with reference to FIG. 5D.

In this process, a comparison is made to the characteristic point data of partial image (PI) (hereinafter referred to as the “characteristic point data of the partial image (PI)”), which is determined in SB2 and one characteristic point data of the attached image (AC) acquired in SA4 (SD1). In SD1, as the characteristic point data of the partial image (PI), one of the plurality of characteristic point data shown in FIG. 8 is selected. In the disclosure, in SD1, the characteristic point data of the partial image (PI) is selected from the characteristic point data in TB1 shown in FIG. 8 in order as named from upside. At present, as shown in FIG. 6, in the plurality of partial images (PI) of the image of external objects (BG), as an image configured with the characteristic point data in TB1 shown in FIG. 8, only the partial image (PI) to correspond to the hub-like image (HB) exists. Thus, in SD1, the characteristic point data configuring the hub-like image (HB) is selected as the characteristic point data of the partial image (PI). When the characteristic point data configuring the hub-like image (HB) is selected as the characteristic point data of the partial image (PI), a comparison is made to the characteristic point data configuring the hub-like image (HB), which is shown in SD1, and the respective characteristic point data of the ID numbers M2A1, M2A2, and M2A3, which are acquired in SA4.

After comparison of characteristic point data, a conformity rate in shape between the partial image (PI) and the respective attached images (AC) of the plurality attached images (AC) is acquired (SD2). That is, the conformity rates in shapes between the hub-like image (HB) and the attached image (AC) of ID number M2A1, between the hub-like image (HB) and the attached image (AC) of ID number M2A2, and between the hub-like image (HB) and the attached image (AC) of ID number M2A3 are acquired. The attached images (AC) of ID numbers M2A1 and M2A2, as shown in FIG. 9, comprise the characteristic point data of hub-like image (HB). Thus, the conformity rates in shapes between the hub-like image (MB) and the attached image (AC) of ID number M2A1, and between the hub-like image (HB) and the attached image (AC) of ID number M2A2 are acquired to have a maximum value of 1.0. Meanwhile, the attached images (AC) of ID number M2A3, as shown in FIG. 9, do not comprise the characteristic point data of hub-like image (HB). Thus, the conformity rate in shape between the hub-like image (HB) and the attached image (AC) of ID number M2A3 is acquired to have a minimum value of 0.0.

When the conformity rate in shape is acquired, it is determined whether or not there is respective attached image (AC) relevant to work being done by a user (PR) (SD3). If in SD3, the conformity rate in shape between the partial image (PI) and the respective attached images (AC) is equal to or above a reference value of 0.8, which is stored on the program ROM 13, it is determined that the attached image (AC) is relevant to the work. If in SD3, the conformity rate in shape between the partial image (PI) and the respective attached images (AC) is below a reference value of 0.8, which is stored on the program. ROM 13, it is determined that the attached image (AC) is not relevant to the work. Since the conformity rate in shape between the hub-like image (RB) and the attached image (AC) of ID number M2A1 and the conformity rate in shape between the hub-like image (FIB) and the attached image (AC) of ID number M2A2 are respectively 1.0, it is determined that the attached image (AC) of ID number M2A1 and the attached image (AC) of ID number M2A2 are relevant to the work. Since the conformity rate in shape between the hub-like image (BB) and the attached image (AC) of ID number M2A3 is 0.0, it is determined that the attached image (AC) of ID number M2A3 is not relevant to the work.

If it is determined that there is an attached image (AC) relevant to work being done by a user (PR) (SD3: Yes), the data of the attached image (AC) of FIG. 9 determined to be relevant to work is supplied to the RAM 15 (SD4). In the disclosure, if the attached image (AC) relevant to work is determined to exist, after SD3, the process proceeds to SD4. In SD4, when the data of attached image (AC) is supplied to the RAM 15, the number of the attached images (AC) to be supplied to the RAM 15 is counted. In the disclosure, the attached image (AC) supplied to the RAM 15 is the attached images (AC) of ID numbers M2A1 and M2A2, so that the count number is “2” in SD4.

If the image data of attached image (AC) is supplied to the RAM 15, it is determined whether or not the partial image (PI) is a last partial image (PI) (SD5). Further, if SD3 determines that there is no attached image (AC) relevant to work (SD3: No), the process proceeds to SD5 to determine whether a partial image (PI) is a last partial image (PI). In SD5, whether or not a partial image (PI) is a last one is determined depending upon whether or not the characteristic point data of the partial image (PI) in determination table (TB1) shown in FIG. 8 is the data provided in the lowest item. As described before, in the external surrounding pickup image (BG), as an image configured by the characteristic point data in table (TB1) shown in FIG. 8, only a hub-like image (HB) exists. Thus, in this case, the partial image (PI) is determined to be a last one.

If SD5 determines that the partial image (PI) is a last one (SD5: Yes), it is determined whether or not there is at least one attached image (AC) which is relevant to work among the plurality of attached images (AC) (SD6). The determination of SD6 is performed based on the number of the attached images (AC) counted in SD4. If the partial image (PI) is determined not to be the last one (SD5: No), the process returns to SD1 and the process after SD1 is performed again in regard of the next partial image (PI). In the disclosure, the hub-like image (HB) is both first and last partial images. Thus, in SD5, it is not determined that the partial image (PI) is not the last one, and the process proceeds to SD6. If SD6 determines that there is at least one attached image (AC) which is relevant to work (SD6: Yes), the process proceeds to SA6. If SD6 determines that there is not at least one attached image (AC) which is relevant to work (SD6: No), the process returns to SA2. As set forth before, the process of SA5 shown in FIG. 5A is executed by a series of processes shown in FIG. 5D.

If it is determined that there is at least one attached image (AC) which is relevant to work, among the plurality of attached images (AC) (SA5: Yes), at least one relevant attached image (AC) is displayed (SA6). If it is determined that there is not at least one attached image (AC) which is relevant to work, among the plurality of attached images (AC) (SA5: No), the process returns to SA2.

When at least one relevant attached image (AC) is displayed in SA6, it is determined whether or not a command to terminate is supplied from the power switch (SW) (SA7). The command to terminate is supplied when a user (PR) turns off the power switch (SW). If it is determined that the command to terminate is not supplied (SA7: No), the process returns to SA2. If the command to terminate is determined to be supplied (SA7: Yes), the process shown in FIG. 5A is terminated.

Next, the process of adding an attached image (AC) of the HMD 1 to the determination table (TB2) will be described with reference to FIG. 5E. The process of FIG. 5E begins when the renewal switch (NW) is turned ON and a command of renewal is supplied. A new attached image (AC) to be added is an image of external objects (BG) which is imaged by the CCD 5 when the renewal switch (NW) is turned ON, and is stored on the RAM 15. Thus, it is determined so that when a user (PR) fails in doing work as shown in FIG. 10B, the renewal switch (NW) is turned ON so that an image of external objects (BG) showing the case of failure as shown in FIG. 10B has to be added to the determination table (TB2) as a new attached image (AC). When the adding process of FIG. 5E begins, it is first determined whether or not a manual image (MN) is displayed when the renewal switch (NW) is turned ON (SE1). If the manual image (MN) is determined to be displayed (SE1: Yes), a new attached image (AC) is supplied to the DB server 200, together with the page data of the manual image which has already been displayed (SE2). The DB server 200 matches new attached images (AC), sequentially supplied from the HMDs 1, 1A, 1B, and 1C, with the page data, and adds the new attached images (AC) and the page data to the determination table (TB2). Specifically, the control unit 230, shown in FIG. 3, stores the new attached images (AC) and the page data in the determination table (TB2), which has been stored on the attached image memory part 220, in a matched form. As illustrated in SE2, the general controller 10 of the HMD 1 supplies not all of images of external objects (BO) imaged by the CCD 5, but an image of external objects (BG), which is determined to be added to the determination table (TB2), to the DB server 200 as a new attached image (AC). Thus, the possibility of the occurrence of a problem of being an excessive burden of information processing to the DB server 200 can be reduced. The processing function of the general controller 10 and SE2 is an example of an image supplying unit. When a new attached image (AC) is supplied to the DB server 200 in SE2, the process of FIG. 5E is terminated. Further, if SE1 determines that the manual image (MN) is not displayed (SE1: No), the process of FIG. 5E is terminated.

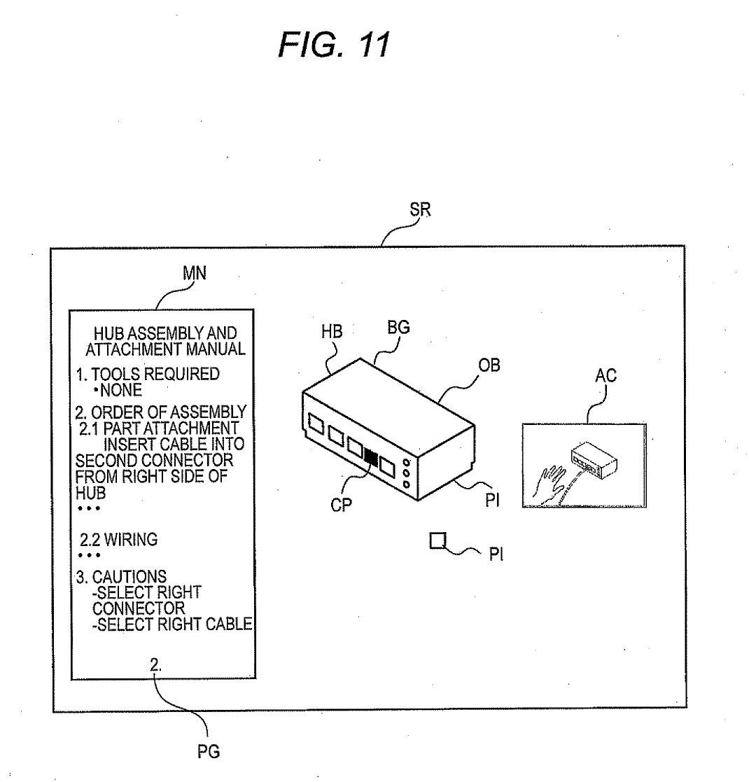

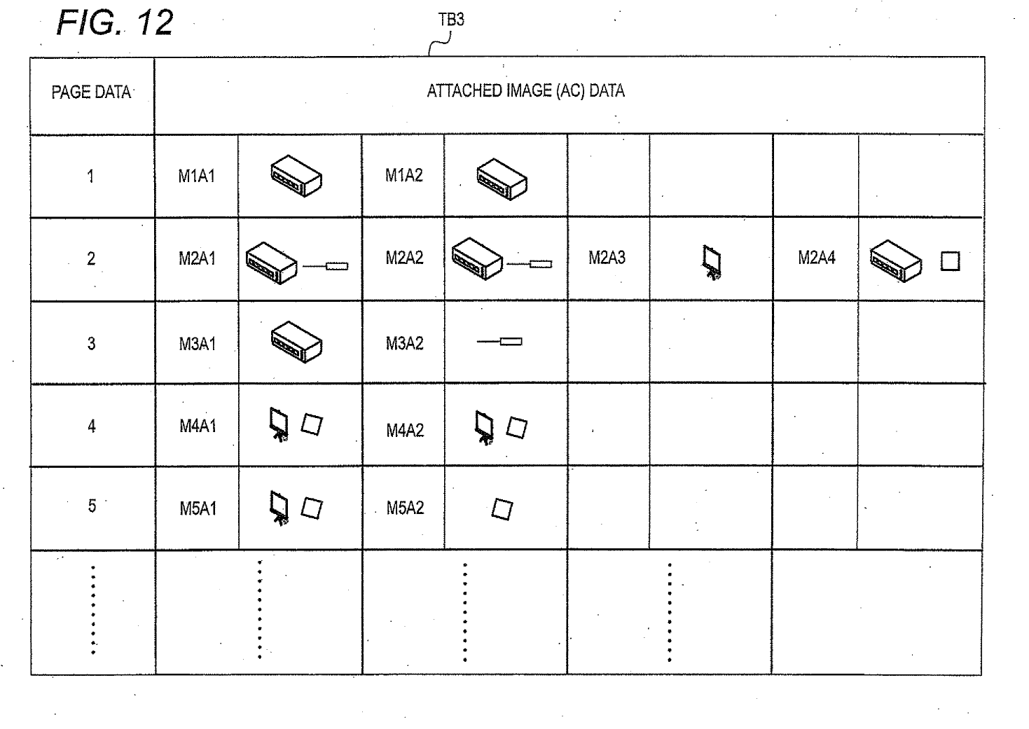

As shown in FIG. 11, assuming that in doing work that a user (PR) inserts a cable (CB) into a certain connector on a target object which is shown as an object image (OB), he/she erroneously mounts a cover plate (CP) onto the corresponding portion. Here, when the user (PR) turns the renewal switch (NW) ON, in SA8, the image of external objects (BG) shown in FIG. 11 is supplied as a new attached image (AC) to the DB server 200, together with the information of “2”, the page data of the manual image (MN). The DB server 200 adds the data of new attached image (AC), in which the new attached image (AC) and the page data are arranged to correspond to each other, to the determination table (TB2) shown in FIG. 9. With addition of new attached image (AC) by the DB server 200, new determination table (TB3) shown in FIG. 12 is drawn up. As shown in FIG. 12, as data of new attached images (AC), data of an attached image (AC) of ID number M2A4 is added to the determination table (TB3). New ID numbers such as M2A4 are sequentially allocated upon renewal by the DB server 200. Like this, according to the image sharing system 100, the new attached images (AC) showing the case of failure, are supplied to the DB server 200 from the HMDs 1, 1A, 1B, and 1C, and the new attached images (AC) are stored in the DB server 200, so that the respective HMDs 1, 1A, 1B, and 1C can share the attached image (AC) showing the case of failure with other HMDs. Further, it is possible to enable respective users to view only the attached image (AC), which is determined to be relevant to work being done by the respective users, among the plurality of attached images (AC), using the process such as SA5.

While the processes shown in FIGS. 5A to 5E are executed by the CPU 12 of the HMD 1 shown in FIG. 3, the aspect of the disclosure is not limited thereto, but the processes may be executed by the DB server 200 shown in FIG. 4. Further, for storage of a variety of data, instead of the flash ROM 14 and the RAM 15 of the HMD 1 shown in FIG. 3, the DB server 200 shown in FIG. 4 may be used.

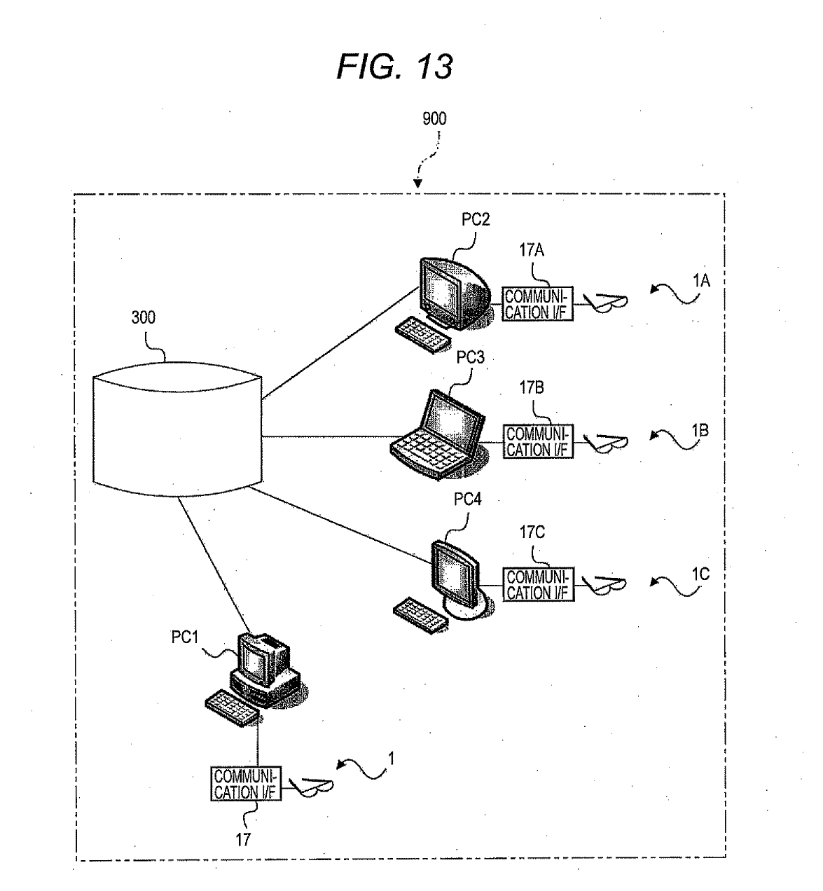

In the above disclosure, the image sharing is carried out by means of data communication between the HMDs 1, 1A, 1B, and 1C and the DB server 200 as shown in FIG. 4. However, the aspect of the disclosure is not limited thereto so that for example, as shown in FIG. 13, the image sharing may be done via a personal computer (called a “PC”). In FIG. 12, HMDs 1, 1A, 1B, and 1C have the same configuration as those of HMD 1 shown in FIGS. 1, 2, and 3. In FIG. 13, a HMD, 1 mounted by a user (PR), and the HMDs 1A, 1B, and 1C, mounted by other three users, are illustrated. The four users wearing the HMDs 1, 1A, 1B, and 1C, respectively also do their work of assembly, attachment or the like as the user (PR) of FIG. 1 does. As shown in FIG. 13, the HMD 1 and the HMDs 1A, 1B, and 1C are connectable to personal computers PC1, PC2, and PC3 through wireless communication via communication I/Fs 17, 17A, 17B, and 17C, respectively. The personal computers PC1, PC2, PC3, and PC4 are connectable to a DB server 300 through wireless communication. When connected to the DB server 300, the personal computers PC1 to PC 4 acquire a manual image (MN) and determination tables (TB1 and TB2) from the DB server 300. The personal computers PC1 to PC4 temporarily stores the manual image (MN) and the determination tables (TB1 and TB2) acquired from the DB server 300. When the HMDs 1, 1A, 1B, and 1C are connected to the personal computers PC1 to PC4, respectively, via wireless communication, the personal computers PC1 to PC 4 supply the manual image (MN) and the determination tables (TB1 and TB2) to the HMDs 1, 1A, 1B, and 1C, respectively. The display processes of the manual image (MN) and the attached image (AC) are carried out by the same method as shown in FIGS. 5A to 5D. Like this, only when the personal computers PC1 to PC4 temporarily store the manual image (MN) and the determination tables (TB1 and TB2) and the HMDs 1, 1A, 1B, and 1C are connected to the personal computers PC1 to PC4, respectively, through wireless communication, the manual image (MN) and the determination tables (TB1 and TB2) are supplied to the HMDs 1, 1A, 1B, and 1C. Thus, the HMDs 1, 1A, 1B, and 1C need not to be always connected to the DB server and the personal computers PC1 to PC4, but are connected thereto only when needing the manual image (MN), determination tables (TB1 and TB2), or the like, so that efficient image sharing is implemented.

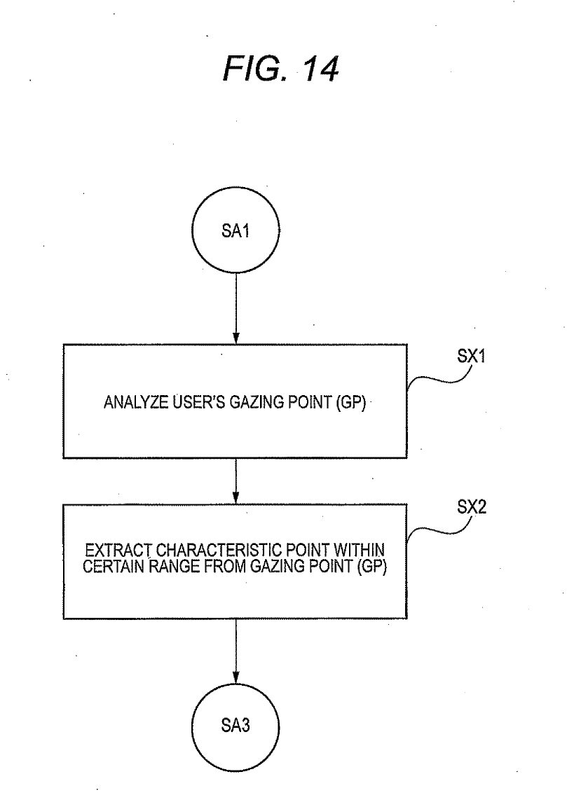

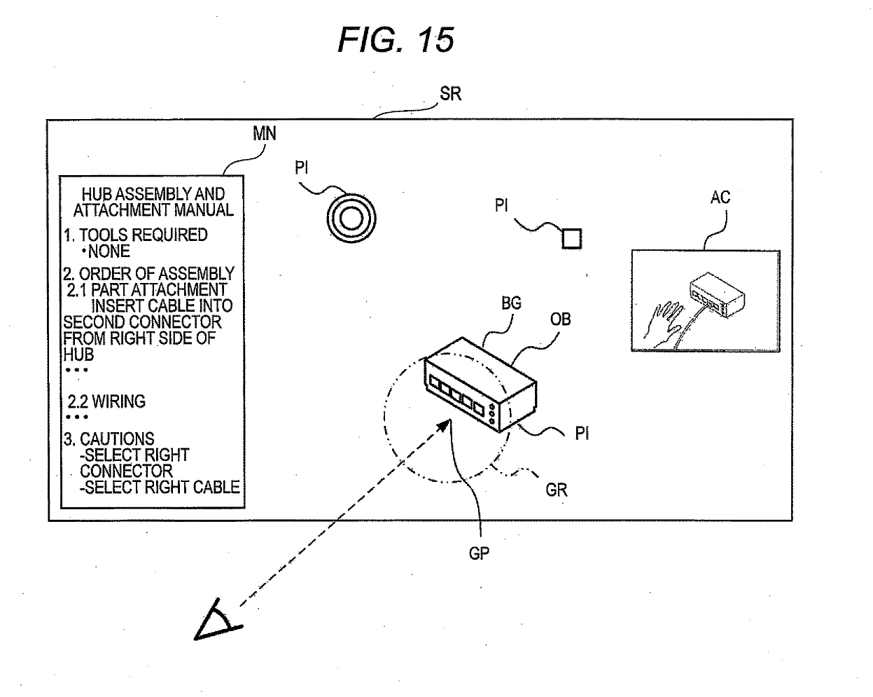

In the above disclosure, whether or not the attached image (AC) is relevant to work had been determined depending upon whether or not the conformity rate in shape between the partial image (PI) and the attached image (AC) is equal to and above the reference value. Here, if the conformity rate is determined to be equal to and above the reference value, and the attached image (AC) is determined to be relevant to work, the partial image (PI) conforming to the shape of the attached image (AC) had been specified as the object image (OB) showing the user's target work in the external objects. However, the aspect of the disclosure is not limited thereto so that for example, the object image may be specified by the configuration of the second modification shown in FIGS. 14 and 15. The process of FIG. 14 replaces SA2 shown in FIG. 5A. In the process of FIG. 14, first a user's gazing point (GP) is analyzed (SX1). Specifically, a direction to which the user's pupil directs is detected, and a location of an intersecting point between the detected direction and the external objects, i.e. the coordinate of the user's gazing point (GP) is acquired. An image within a certain range about the acquired intersecting point is specified as an object image. In SX1, when the user's gazing point is analyzed, as shown in FIG. 15, a characteristic point within a certain range from the gazing point (GP) is extracted (SX2). That is, while in SA2 shown in FIG. 5A, all characteristic points in the image of the external objects were extracted, according to the modification, only the characteristic points within a certain range from the gazing point (GP) are extracted. Thus, when comparing with SA2 shown in FIG. 5A, in case of SX2 shown in FIG. 14, the characteristic points can be extracted faster. In the modification, the HMD comprises for example a eye-imaging unit for imaging the user's eye, so as to calculate the center of an image of the user's eye, which is imaged by the eye-imaging unit, thereby detecting the direction to which the user's eye directs. Further, the eye-imaging unit is installed on the frame portion 2, for example, as shown in FIG. 1. The image data of the user's eye, acquired by the eye-imaging unit, is stored on the RAM 15 via the bus 18 shown in FIG. 3. When the image data of the user's eye is stored on the RAM 15, the user's gazing point (GP) is analyzed in SX1 by the CPU 12. The eye-imaging unit of the second modification is an example of an eye-imaging unit. The CPU 12 is an example of a position-calculating unit.

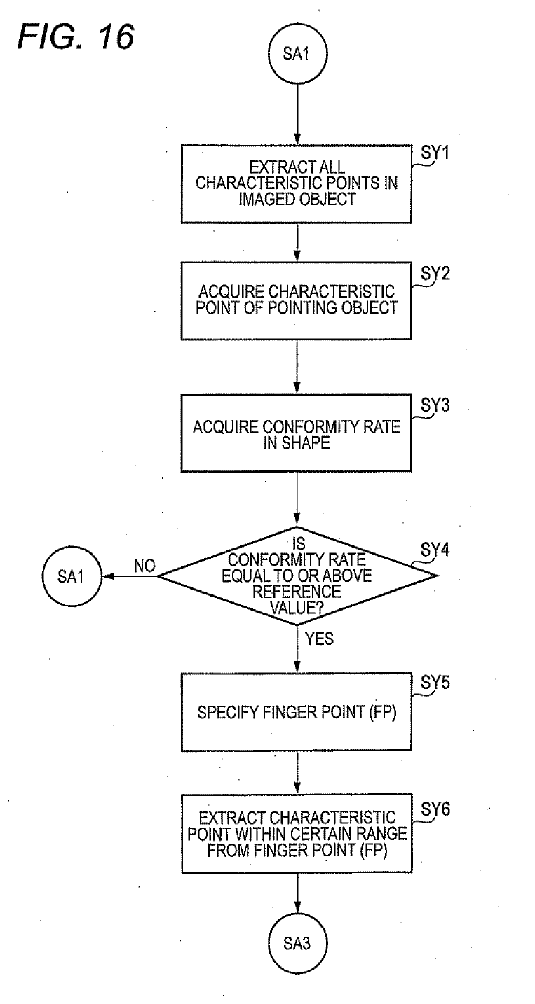

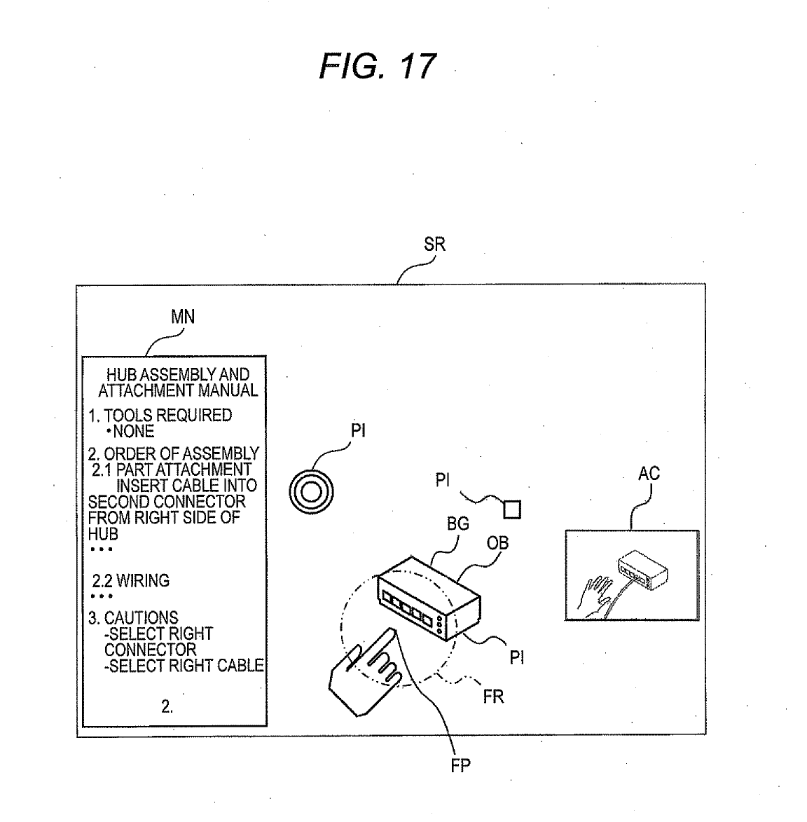

In the above disclosure, whether or not the attached image (AC) is relevant to work had been determined depending upon whether or not the conformity rate in shape between the partial image (PI) and the attached image (AC) is equal to and above the reference value. Here, if the conformity rate is determined to be equal to and above the reference value, and the attached image (AC) is determined to be relevant to work, the partial image (PI) conforming to the shape of the attached image (AC) had been specified as the object image. However, the aspect of the disclosure is not limited thereto so that for example, the object image may be specified by the configuration in FIGS. 16 and 17. The process of FIG. 16 replaces SA2 shown in FIG. 5A. In the process of FIG. 16, first all characteristic points in the image of external objects are extracted (SY1). This process is carried out by the same method as that shown in FIG. 5A. When all characteristic points in the image of external objects are extracted, a pointing image of a characteristic point is acquired (SY2). The pointing image is a user's finger image, which is stored on the flash ROM 14 shown in FIG. 3 in advance. When the characteristic point of the pointing image is acquired, the conformity rate in shape is calculated based on the characteristic points extracted in SY1 and the characteristic point of the pointing image extracted in SY2 (SY3). The process of SY3 is executed by the same method as that of SD2. If the conformity rate in shape is acquired, it is determined whether or not the conformity rate acquired is equal to or above a reference value (SY4). The process of SY4 is executed by the same method as that of SD3. If the conformity rate is determined to be below the reference value (SY4: No), the user's finger is determined not to be within the image of external objects and the process returns to SA1. If the conformity rate is determined to be equal to or above the reference value (SY4: Yes), the user's finger is determined to be within the image of external objects and the process proceeds to SY5. If the conformity rate is determined to be equal to or above the reference value (SY4: Yes), a finger point (FP) is specified as shown in FIG. 17, based on the coordinate data of the finger point in the pointing image (SY5). If the finger point (FP) is specified, characteristic points within a certain range (FR) from the finger point (FP) shown in FIG. 17 (SY6). In the process of FIG. 16, all characteristic points in the image of external objects are once extracted in SY1, and then the characteristic points within the certain range (FR) are extracted again in SY6. Thus, as compared to SA2 shown in FIG. 5A, according to the extracting process of FIG. 16, the characteristic points can be precisely extracted. The CPU 12 is an example of a finger-recognizable unit.

In the above disclosure, in the determination tables (TB1 and TB2) shown in FIGS. 8 and 9, the page data of the manual image (MN) are arranged to correspond to the characteristic point data. However, the aspect of the disclosure is not limited thereto so that for example, instead of the page data, index data showing a chapter or an item of the manual image may be stored in a form matched with the characteristic point data.

While the above disclosure has described that the manual image (MN), the determination tables (TB1 and TB2) and the like are stored in the DB server 200, the aspect of the disclosure is not limited thereto so that for example, they may be stored on the flash ROM of the HMD.

According to the aspect of the disclosure, as shown in FIG. 5E, if SE1 determined that the manual image (MN) was not displayed, the process of FIG. 5E was terminated. However, the aspect of the disclosure is not limited thereto so that for example, even in the case that the manual image (MN) is not displayed, if a user turns on the renewal switch (NW) and manipulates the keyboard or the like attached to the HMD, the page data of the manual image can be designated, and new attached images (AC) may be supplied to the DB server, together with the page data of the manual image designated by the user. In this case, a page designating unit such as certain keyboards is connected to the general controller shown in FIG. 3 via certain I/F or the like.

What is claimed is:

1. A head mounted display external objects comprising:
an imaging unit configured to image external objects;
a first image acquiring unit configured to acquire a first image which shows first information of the work being done by the user;
a second image acquiring unit configured to acquire a plurality of second images which are relevant to specific parts of the first image, the second images showing second information relevant to the first information of the work shown by the first image;
a determining unit configured to determine whether or not the plurality of second images are relevant to the work being done by the user, based on the image of external objects;
an image forming unit configured to form, by an image beam, the first image and at least one of the second images determined by the determining unit to be relevant to the work being done by the user.

2. The head mounted display apparatus according to claim 1, wherein
the first image comprises a manual image, the contents of which is sequentially converted according to a state of the work being done by the user, in order to show contents and order of the work to the user according to the state of work being done by the user, and
the specific parts of the first image comprises a page number or an index attached to the manual image.

3. The head mounted display apparatus according to claim 1 further comprising a specifying unit configured to specify an object image which is relevant to the work which the user are doing, in the external objects, and
wherein the determining unit determines the second image that is relevant to the object image.

4. The head mounted display apparatus according to claim 3, comprising a shape-recognizable unit configured to recognize a partial shape of a plurality of partial images, which is a part of the external objects,
wherein the specifying unit specifies, as the object image, the partial image having the partial shape conforming to the shape of any one of the second images.

5. The head mounted display apparatus according to claim 3, comprising:
a eye-imaging unit configured to image an eye of the user; and
an point-acquiring unit configured to acquire an intersecting point between a direction to which the user's eye directs, and the image of the external objects,
wherein the specifying unit specifies, as the object image, the partial image at the intersecting point, which is a part of the image of the external objects.

6. The head mounted display apparatus according to claim 3 further comprising a finger-recognizable unit configured to recognize a finger shape of a finger image of the user, which is a part of the image of the external objects,
wherein the specifying unit specifies, as the object image, the partial image pointed by the finger image, which is a part of the plurality of partial images.

7. The head mounted display apparatus according to claim 1, wherein the first information comprises contents and order of the work, and the second information comprises an image of a successful case where the work related to the first information is successfully done or an image of a case of failure of failure where the work related to the first information is failed.

8. An image sharing system comprising:
the plurality of head mounted display apparatuses according to claim 1; and
an information processing unit connected to the head mounted display apparatuses,
wherein each of the head mounted display apparatuses comprises an image supplying unit configured to supply the image of the external objects to the information processing unit,
wherein the information processing unit comprises:
a first image memory part that stores the first image in advance;
a second image memory part that stores the second image in advance; and
a control unit storing, as new second images, the plurality of the image of external objects supplied from the image supplying units of the plurality of head mounted display apparatuses, in the second image memory part,
wherein the first image acquiring unit acquires the first image stored in the information processing unit,
wherein the second image acquiring unit acquires the plurality of second images stored in the information processing unit.

9. A method of controlling a head mounted display apparatus comprising:
imaging external objects;
acquiring a first image which shows first information of the work being done by the user, which is relevant to the external objects;
acquiring a plurality of second images which are relevant to specific parts of the first image, the second images showing second information relevant to the first information of the work shown by the first image;
determining whether or not the plurality of second images are relevant to the work being done by the user, based on the external objects;
forming, by an image beam, the first image and at least one of the second images determined by the determining unit to be relevant to the work being done by the user.
